(19) United States
(12) Patent Application Publication
(10) Pub. No.: US 2015/0096731 A1
(43) Pub. Date: Apr. 9, 2015

(54) Device and System for Dissipating Heat, and Method of Making Same

(71) Applicant: Specialty Minerals (Michigan) Inc., Bingham Farms, MI (US)

(72) Inventors: Donald Ray Koch, Easton, PA (US); Robert John Moskaitis, Easton, PA (US)

(21) Appl. No.: 14/046,001

(22) Filed: Oct. 4, 2013

(51) Int. Cl. F28F 3/00; B29C 53/04; F28F 21/02

(52) U.S. Cl. CPC F28F 3/00; F28F 21/02; B29C 53/043; B29K 2105/256
USPC 165/185; 29/428; 264/339

(57) ABSTRACT

A device and system for dissipating heat includes a bent portion of pyrolytic graphite in which a-b planes at a center region of the bent portion follow a surface contour of the bent portion. A method for making a heat dissipating device includes bending a flat sheet of pyrolytic graphite such that a-b planes at a center region of a bent portion follow a surface contour of the bent portion.

### FIELD OF THE INVENTION

The present invention relates to a device and system for dissipating heat and a method for making the same, and more particularly to a heat dissipating device made of planar thermal conductive material.

### BACKGROUND OF THE INVENTION

Miniaturization, increased complexity and/or increased functional capacity of various devices, such as electronic assemblies and individual components, often results in more heat being generated which must be dissipated to maintain performance and avoid damage. Conventional methods for dissipating heat may fail to satisfy cooling requirements and design constraints relating to physical size, weight, power consumption, cost, or other parameters. Accordingly, there is a continuing need for an efficient means for dissipating heat from a variety of heat sources.

### SUMMARY OF THE INVENTION

Briefly and in general terms, the present invention is directed to a device and a system for dissipating heat and a method for making the same.

In aspects of the present invention, a device comprises a sheet including a flat first portion and a bent second portion integrally formed on the first portion, wherein each of the first portion and the second portion has a core substrate that consists essentially of pyrolytic graphite, and a-b planes of the pyrolytic graphite at a center region of the first portion and the second portion follow a surface contour of the first portion and the second portion.

Any one or a combination of two or more of the following features can be appended to the aspect above to form additional aspects of the invention.

The a-b planes at the center region of the second portion have a bend angle of at least 15°.

The sheet further includes a flat third portion integrally formed on the second portion, the third portion consists essentially of pyrolytic graphite, and central a-b planes of the pyrolytic graphite running between the first portion and the third portion bend at least 15°.

The sheet further includes a curved fourth portion integrally formed on the third portion, the fourth portion consists essentially of pyrolytic graphite, and a-b planes at a center region of the fourth portion have a bend angle of at least 15°.

The device further comprises a cover disposed over any one or more of the portions of the sheet.

The cover includes two opposing layers, and any one or more of the portions of the sheet is or are disposed between the two opposing layers.

All the portions of the sheet are sealed within the cover.

The cover includes a metal foil.

The cover includes a polymer layer having a greater dielectric resistance relative to underlying material beneath the polymer layer.

The cover includes a metal mesh configured to accommodate a difference in thermal expansion between the sheet and a heat source to be thermally coupled to the sheet.

In aspects of the present invention, a system comprises the device according to any one of the aspects above, and a heat source thermally coupled to the device.

In aspects of the present invention, a method comprises bending a sheet of pyrolytic graphite to form a bent portion, wherein a-b planes of the pyrolytic graphite at a center region of the bent portion follow a curved surface contour of the bent portion.

Any one or a combination of two or more of the following features can be appended to the aspect above to form additional aspects of the invention.

The bending step includes bending central a-b planes at least 15°.

After the bending step, two portions of the sheet are flat, and the bent portion is disposed between the two portions.

The two flat portions are offset and parallel to each other.

A-b planes at center regions of the two flat portions are flat, and the a-b planes at the center region of the bent portion are curved.

The bending step includes one or both of roll forming and press forming.

The method further comprises applying a cover over the bent portion or another portion of the sheet.

The cover includes any one or more of a metal layer portion, a polymer layer portion, and a mesh portion.

At least one portion of the cover is applied during the bending step.

The features and advantages of the invention will be more readily understood from the following detailed description which should be read in conjunction with the accompanying drawings.

### BRIEF DESCRIPTION OF THE DRAWINGS

FIG. 1 is an isometric view showing a flat sheet of planar thermal conductive material.

FIGS. 2A and 2B are an isometric view and a cross-section view showing a heat dissipating device consisting of a curved sheet of planar thermal conductive material.

FIGS. 3A and 3B are an isometric view and a cross-section view showing rollers for making a heat dissipating device having a bent portion.

FIG. 3C is an isometric view showing the flat sheet of FIG. 1 being fed into the rollers of FIGS. 3A and 3B to form the heat dissipating device of FIGS. 2A and 2B.

FIGS. 4A and 4B are an isometric view and a cross-section view showing plates for making a heat dissipating device having a bent portion.

FIGS. 5A and 5B are an isometric view and a cross-section view showing a heat dissipating device having multiple flat portions and multiple bent portions, all of which portions have a core substrate consisting essentially of planar thermal conductive material, and the core substrate having cavities occupied by various components.

FIG. 6 is a cross-section view of a portion of a heat dissipating device, showing two layers of a cover applied over a core substrate consisting essentially of planar thermal conductive material.

All drawings are schematic illustrations and the structures rendered therein are not intended to be in scale. It should be understood that the invention is not limited to the precise arrangements and instrumentalities shown, but is limited only by the scope of the claims.

### DETAILED DESCRIPTION OF EXEMPLARY EMBODIMENTS

As used herein, the phrase “integrally formed on,” when used to describe the relationship between two structures, means the two structures have a unitary construction in that there is no seam or junction that completely separates the two structures, which is different from a type of construction in which the two structures are initially separate and then subsequently joined together.

As used herein, the phrase “consisting essentially of” limits the structure being modified by the phrase to the specified material(s) and other materials that do not materially affect the basic characteristics provided by the specified material to the structure.

As used herein, the phrase “thermally coupled” refers to a physical heat conduction path from a first structure to a second structure. The first and second structures can be in direct contact with each other. The first and second structures can optionally be separated from each other by an intervening structure which provides a physical thermal bridge between the first and second structures.

As used herein, a “planar thermal conductive material” is a material having a greater thermal conductivity in directions that lie on a particular plane or are parallel to the plane, as compared to directions which do not lie on the plane and directions which are not parallel to the plane.

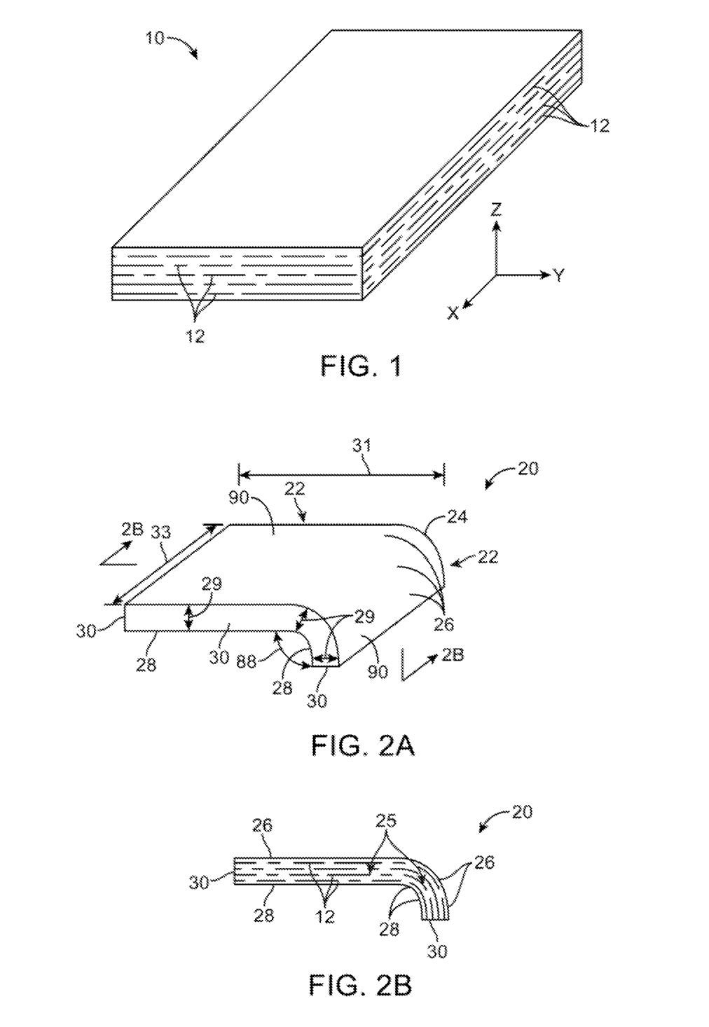

Referring now in more detail to the exemplary drawings for purposes of illustrating embodiments of the invention, wherein like reference numerals designate corresponding or like elements among the several views, there is shown in FIG. 1 a flat sheet 10 of planar conductive material having enhanced thermal conductivity in a particular direction dependent upon the arrangement of atoms and atomic bonds in microscopic regions of the material. The directions in which sheet 10 has greater thermal conductivity is selected based on the desired use application of a heat dissipating device to be made from sheet 10.

In FIG. 1, orthogonal axes indicate the x-, y-, and z-directions relative to sheet 10. The x-direction is coplanar with and perpendicular to the y-direction. The z-direction is perpendicular to the x- and y-directions. The x- and y-directions define the x-y plane, the x- and z-directions define the x-z plane, and the y- and z-directions define the y-z plane.

Sheet 10 consists essentially of the planar thermal conductive material having an atomic structure in which atoms are arranged in an orderly manner in a plurality of stacked planes (referred to “a-b planes”) substantially parallel to each other. In a direction (referred to as a “c-direction”) perpendicular to the a-b planes, the atoms are irregularly arranged or have a less orderly arrangement.

Referring to FIG. 1, sheet 10 is flat and the a-b planes of the planar thermal conductive material of sheet 10 are parallel to the x-y plane. The c-direction of the planar thermal conductive material is parallel to the z-direction. Edges 12 of the a-b planes are illustrated with parallel straight lines to indicate the orientation of the a-b planes. It is to be understood that the a-b planes are microscopic.

An example of a suitable planar thermal conductive material is pyrolytic graphite, which would provide sheet 10 with enhanced thermal conductivity in a particular direction dependent upon the orientation of planar layers of ordered carbon atoms. Carbon atoms of pyrolytic graphite are arranged hexagonally in planes (referred to as a-b planes), which facilitate heat transfer and greater thermal conductivity in directions on the a-b planes. The carbon atoms have an irregular or less orderly arrangement in directions which do not lie on the a-b plane, which results in diminished heat transfer and lower thermal conductivity in those directions. Thermal conductivity of pyrolytic graphite in directions on a-b planes can be more than four times the thermal conductivity of copper and natural graphite, and more than five times the thermal conductivity of beryllium oxide. Thermal conductivity of pyrolytic graphite for use in any of the embodiments described herein can be in the range of 304 W/m-K to 1700 W/m-K in directions on a-b planes, and 1.7 W/m-K to 7 W/m-K in directions (referred to as c-directions) perpendicular to the a-b planes. The thermal conductivity values are those at standard room temperature from 20° C. to 25° C. Pyrolytic graphite having these characteristics can be obtained from Pyrogenics Group of Minteq International Inc. of Easton, Pennsylvania, USA.

The compositional purity of the planar thermal conductive material will affect thermal conductivity. In some embodiments, sheet 10 is constructed such that its thermal conductivity in a first direction corresponding to a-b planes of pyrolytic graphite is at least 100 times or at least 200 times that in a second direction corresponding to a c-direction.

A device for dissipating heat can be fabricated from flat sheet 10 of FIG. 1. For example, the heat dissipating device can include a curved sheet of planar thermal conductive material. The sheet includes a flat first portion and a bent second portion integrally formed on the first portion. Each of the first portion and the second portion has a core substrate that consists essentially of the planar thermal conductive material. The device can have any number of flat portions and bent portions which are integrally formed on each other. The a-b planes of the planar thermal conductive material follow a surface contour of the first portion and the second portion. The surface contour corresponds to one of the two opposing surfaces of the sheet, not to an edge surface along the perimeter of the sheet. By following the curvature of a referenced surface (for example, the two opposing surfaces of the sheet), the a-b planes are flat below an area of the referenced surface where the referenced surface is flat and are curved below an area of the referenced surface where the referenced surface is curved.

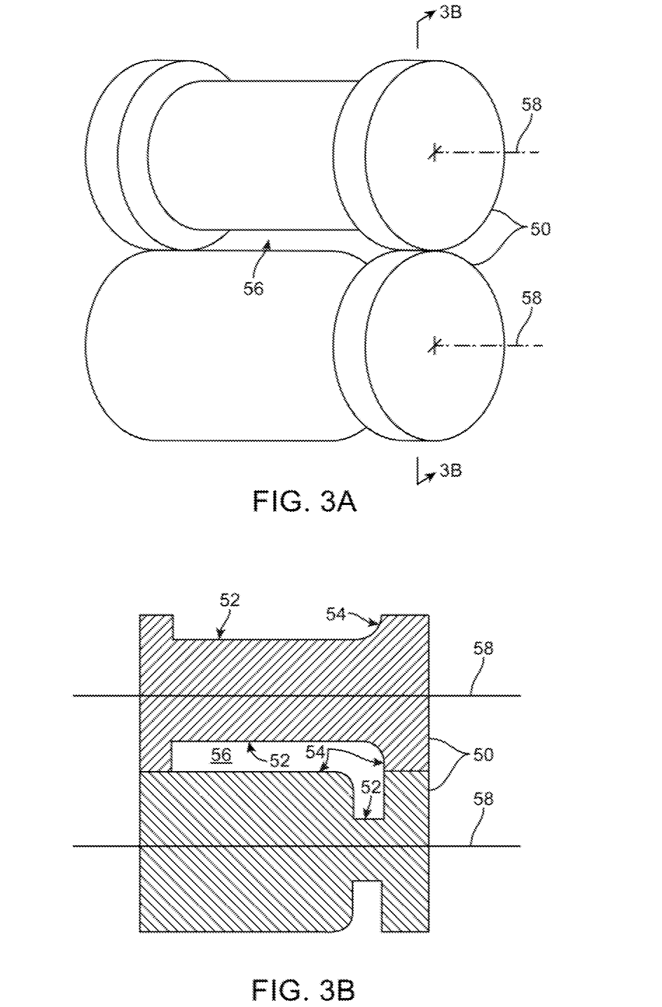

FIGS. 2A and 2B show heat dissipating device 20 formed from sheet 10. Device 20 is a curved, L-shaped sheet having flat leg portions 22 connected to each other by bent portion 24. Bent portion 24 is integrally formed on leg portions 22. Bent portion 24 and leg portions 22 have a core substrate 25 that consists essentially of planar thermal conductive material. The planar thermal conductive material extends continuously through leg portions 22 and bent portion 24. Each of leg portions 22 and bent portion 24 has two opposing surfaces 26 and 28. The a-b planes adjacent to surfaces 26 and 28 and the center of leg portions 22 are flat.

The a-b planes (schematically represented in part by lines 12) adjacent to the surface of bent portion 24 and at the center of bent portion 24 are curved and follow the curvature of both surfaces 26 and 28. The a-b planes adjacent to surfaces 26 and 28 and at the center of bent portion 24 are not flat, such that the high thermal conductivity pathway provided by the a-b planes has a bend or a turn. The a-b planes at a center region of thickness 29 of any portion 22, 24 are referred to as central a-b planes and are located equidistant from opposing surfaces 26 and 28. In order to follow the curvature of opposing surfaces 26 and 28, central a-b planes of bent portion 24 need not have the same curvature radius as surfaces 26 and 28. For example, the central a-b planes of bent portion 24 can have a curvature radius that is less than the curvature radius of surface 26 and greater than the curvature radius of surface 28.

In the illustrated embodiment, the a-b planes and the high thermal conductivity pathway are straight in the first leg portion and then turn or bend 90° before straightening out in the second leg portion. In other embodiments, the a-b planes and the high thermal conductivity pathway turn or bend at an angle other than 90°.

The distance separating opposing surfaces 26 and 28 defines thickness 29 of leg portions 22 and bent portion 24. Thickness 29 can be seen on edge surfaces 30 on the perimeter of leg portions 22 and bent portion 24. Thickness 29 can be about ¼ inch (6 mm). Alternatively, thickness 29 can be less than or greater than ¼ inch. Length 31 of device 20 can be at least 1 inch (25 mm). Width 33 of device 20 can be at least ¼ inch.

The length and width can smaller depending on the intended application of the heat dissipating device.

Flat surfaces 90 on opposite sides of bent portion 24 facilitate attachment to structures which provide and draw away heat. An advantage of bent portion 24 is that heat dissipating device 20 can provide a high thermal conductivity pathway between structures separated by relatively large distances and which have surfaces that are not necessarily parallel or in-line with each other. For example, heat transfer between structures having surfaces separated by 2 inches (51 mm) and oriented 30° from each other can be accomplished using device 20 having length 31 of at least 2.5 inches (64 mm) and a bend angle of 30° instead of the 90° shown in FIGS. 2A and 2B.

A method for forming device 20 may include a bending step performed on flat sheet 10 of FIG. 1. The bending step may include any one or a combination of roll forming and press forming.

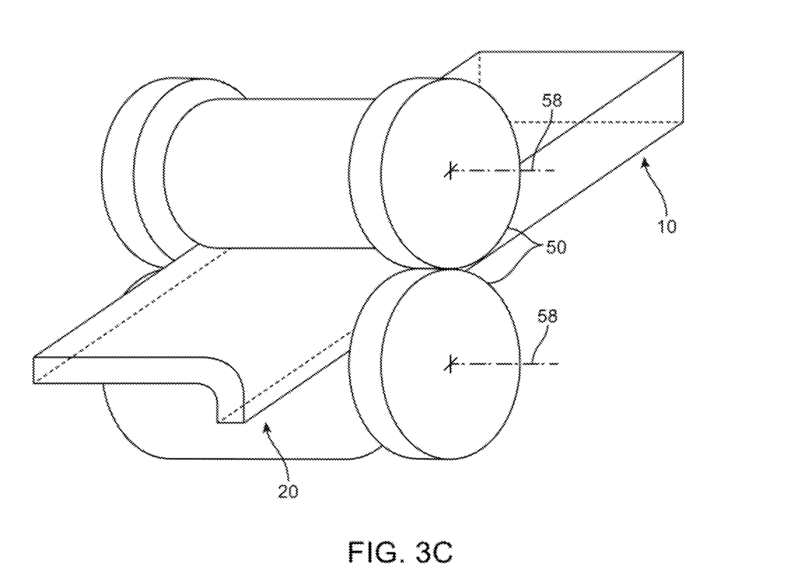

FIGS. 3A to 3C show a pair of cylindrical rollers 50 which can be used in a roll forming operation to form device 20 of FIGS. 2A and 2B from a flat sheet of planar thermal conductive material. Rollers 50 include grooves 52 and protrusions 54 for creating leg portions 22 and bent portion 24. Grooves 52 and protrusions 54 define gap 56 between rollers 50. Gap 56 has a shape that matches the cross-sectional shape of device 20 shown in

FIG. 2B. As shown in FIG. 3C, sheet 10 of FIG. 1 (which in some embodiments is a flat, malleable piece of pyrolytic graphite) can be forced through gap 56 (FIGS. 3A and 3B) to form device 20. Rotation of rollers 50 about their respective axes of symmetry 58 can help force sheet 10 into gap 56. The pressure applied by rollers 50 will bend the normally flat a-b planes so that a-b planes near the surface and at the center of the bent portion follow the surface curvature of gap 56 shown in FIG. 2B and also follow the surface curvature of the resulting curved sheet of the planar thermal conductive material.

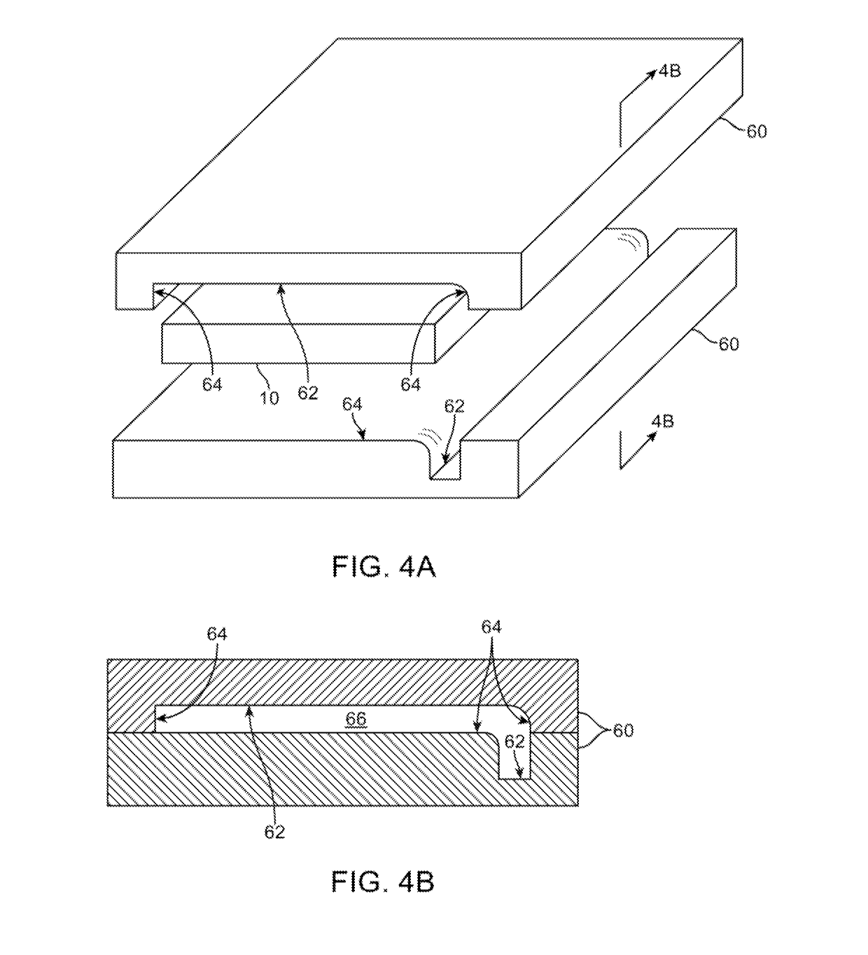

FIGS. 4A to 4B show a pair of platens or plates 60 which can be used in a press forming operation to form device 20 of FIGS. 2A and 2B from a flat sheet of planar thermal conductive material. Plates 60 include grooves 62 and protrusions 64 for creating leg portions 22 and bent portion 24 (FIGS. 2A and 2B). Grooves 62 and protrusions 64 define cavity 66 having a shape that matches the cross-sectional shape of device 20 shown in FIG. 2B. Sheet 10 of FIG. 1 (which in some embodiments is a flat, malleable piece of pyrolytic graphite) can be placed between plates 20 which have been separated from each other. When plates 60 are pressed together, pressure applied to opposing surfaces of sheet 10 forces the flat sheet to take the shape of cavity 66. The pressure applied by plates 60 will bend the normally flat a-b planes so that a-b planes adjacent to the surface and at the center of the bent portion 24 follow the surface curvature of plates 60 and also follow the surface curvature of the resulting curved sheet of the planar thermal conductive material. Thereafter, plates 60 are separated and the resulting curved sheet can be removed.

Optionally after the flat sheet is roll formed or press formed, edges of the curved sheet can be trimmed and cut to make device 20 having any desired size. Cavities or holes can be drilled or punch through the curved sheet and components can be inserted therein to facilitating mounting of device 20.

It will be appreciated that a flat sheet of planar thermal conducive material can be used to fabricate a heat dissipating device having any number of bent portions and flat portions by performing a series of roll forming and/or press forming steps. After one bent portion is made, another forming step can be performed to make another bent portion. It will also be appreciated that multiple bent portions can be formed simultaneously by a correspondingly shaped gap between rollers and/or a correspondingly shaped cavity between plates.

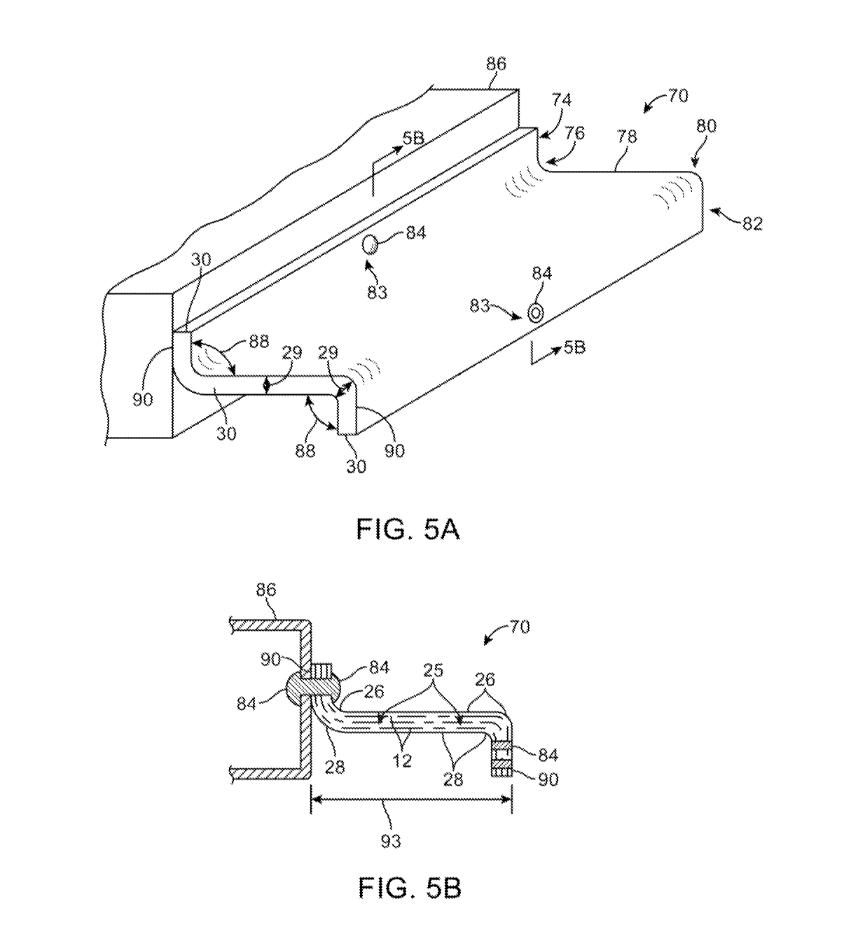

Referring to FIGS. 5A and 5B, heat dissipating device 70 is a curved, Z- or S-shaped sheet having core substrate 25 that consists essentially of planar thermal conductive material. The entire sheet has a unitary construction and includes a flat first portion 74, a bent second portion 76, a flat third portion 78, a bent fourth portion 80, and a flat fifth portion 82. All the portions are integrally formed on each other and are made of a material consisting essentially of planar thermal conductive material. In each one of the portions 74, 76, 78, 80, and 82 the a-b planes (schematically represented in part by lines 12) adjacent to the surface and at the center of thickness 29 follow the contours of any one or both of the opposing surfaces 26 and 28. In flat portions 74, 78, and 82, the a-b planes adjacent to the surface and at the center of thickness 29 are flat. In bent portions 76 and 80, the a-b planes adjacent to the surface and at the center of thickness 29 are curved.

Holes or cavities 83 may be formed into core substrate 25. Various components 84 can be inserted into cavities 83 and attached to device 70. Examples of such components include without limitation screws, bolts, rivets, threaded inserts, clips, clamps, cables, straps, and any combinations thereof. Cavities 83 may also be occupied by filler material such as an adhesive or epoxy. Such components and filler material may be used to thermally couple device 70 to heat source 86 or intervening structure 86 thermally coupled to a heat source. Examples of a heat source include without limitation electric power assemblies, power convertors, and electronic parts (such as semiconductors, integrated circuits, transistors, diodes, etc.) and any combination thereof. Examples of an intervening structure include without limitation a heat sink, a heat spreader, a printed circuit board, a standoff, a rail, and any combination thereof. It should be understood that even if components 84 and filler material do not contain planar thermal conductive material, core substrate 25 of each one of the portions 74, 76, 78, 80, and 82 consists essentially of the planar thermal conductive material.

The bends or turns in the a-b planes of bent portions 76 and 80 provide a high thermal conductivity pathway between structures separated by relatively large distances and which have surfaces that are offset from each other. Flat mounting surfaces 90 on opposite ends of heat dissipating device 70 are parallel to each other and are offset from each other by distance 93 (FIG. 5B). Flat mounting surfaces 90 allow for large surface contact with two structures such as a heat source and a heat sink. For example, a heat source can mounted to one of the flat surfaces 90 and a heat sink can or rail can be mounted to the other flat surface 90. If a heat source and heat sink are separated by a fixed distance, then device 70 can be fabricated so that distance 93 is equivalent to the fixed distance. In alternative embodiments, the heat dissipating device can be U-shaped, instead of the illustrated of Z- or S-shape, and still provide parallel mounting surfaces.

The bend radii of a bent portion can be selected based on the intended application of heat dissipating device 20, 70, so that the bent portion has a sharper or more rounded corner than what is illustrated herein.

The flat portions of any of the heat dissipating devices herein can be oriented relative to each other to form interior angle 88 (FIG. 2A and 5A) other 90°. For example, interior angle 88 between two flat portions can be less than or greater than 90°. In other embodiments, any of the bent portions 76 and 80 can have interior angle 88 other than 90° to provide a high thermal conductivity pathway between structures which are not parallel to each other.

The sum of interior angle 88 and its supplementary angle equals 180°. The supplementary angle of interior angle 88 defines the turn or bend created in the a-b planes of the planar thermal conductive material. For example, when the interior angle is 150°, the a-b planes of planar thermal conductive material in core substrate 25 turns or bends 30°. In some embodiments, flat sheet 10 is processed so as to bend the a-b planes at least 15°, at least 30°, at least 45°, at least 60°, or at least 90°. In some embodiments, the a-b planes adjacent to the surface and at the center of thickness 29 in any bent portion of the heat dissipating device have a bend angle of at least 15°, at least 30°, at least 45°, at least 60°, or at least 90°. In some embodiments, the a-b planes throughout the entire thickness 29 between any two flat portions (for example in bent portion 24 between leg portions 22 in FIG. 2A or in bent portion 76 between portions 74 and 78 in FIG. 5A) device have a bend angle of at least 15°, at least 30°, at least 45°, at least 60°, or at least 90°.

Any of the heat dissipating devices above can include a cover which can serve any number of purposes. For example, a cover as described below can be disposed between flat surface 90 (FIGS. 2A and 5A) and a heat source or an intervening structure thermally coupled to a heat source. The cover can improve the strength and integrity of heat dissipating device 20, 70. The cover can help keep particles of the planar thermal conductive material from separating or shedding from the heat dissipating device before, during, and/or after fabrication. The cover can provide a mounting interface that can facilitate bonding or soldering of a heat source or other component to the heat dissipating device. The cover can also serve as a buffer to accommodate a difference in thermal expansion between the heat dissipating device and a heat source or other component. The cover can be an electrical insulator and have a greater dielectric resistance than the planar thermal conductive material.

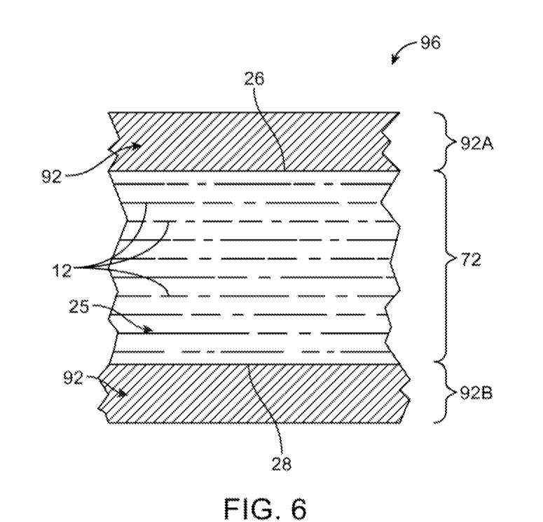

FIG. 6 shows portion 96 of any of the heat dissipating devices described above can optionally have cover 92 applied directly on opposing surfaces 26 and 28 of core substrate 25. In the illustrated embodiment, cover 92 has two opposing layers 92A and 92B. In other embodiments, cover 92 includes only one layer 92A or 92B applied directly on one of opposing surfaces 26 and 28.

Any one or both of layers 92A and 92B may include any one or a combination of the following cover portions: a thin metal layer; a thin polymer layer having a greater dielectric resistance relative to underlying material beneath the polymer layer; and a mesh configured to accommodate a difference in thermal expansion between the heat dissipating device and a heat source or other component. With respect to the polymer layer, the underlying material can be the planar thermal conductive material, a thin metal layer, or a mesh.

A metalizing process can be performed to deposit a thin metal layer over core substrate 25. A potentially less expensive alternative to metalizing is to apply a pre-formed metal foil to the core substrate. The metal foil can be an alloy of copper, silver, gold or another metal having a greater thermal conductivity compared to most other metals. In some embodiments, the thin metal layer (such as a metal foil) is applied directly to the core substrate. In alternative embodiments, the metal layer is disposed above a polymer layer or a mesh applied directly to the core substrate.

The polymer layer can be a conformal coating which is applied by dip coating or spray coating. The polymer layer can have a greater dielectric resistance relative the planar thermal conductive material of core substrate 25. In some embodiments, the polymer layer is applied directly to the core substrate. In alternative embodiments, the polymer layer is disposed above a mesh or a metal layer applied directly to the core substrate.

The mesh can be a copper wire mesh or other metal having a greater thermal conductivity compared to most other metals. The mesh can be flexible. The mesh can have a coefficient of thermal expansion that is greater than or less than that of the planar thermal conductive material. In some embodiments, the mesh can be applied directly to core substrate 25. In alternative embodiments, the mesh is disposed above a polymer layer or metal layer applied directly to the core substrate.

In some embodiments, the metal layer, polymer layer, and/or mesh of cover 92 completely encapsulate the entire curved sheet of planar thermal conductive material. When completely encapsulated, cover 92 covers all opposing surfaces 26 and 28 and edge surfaces 30 (FIGS. 2A, 2B, 5A and 5B). In alternative embodiments, the metal layer, polymer layer, and/or mesh cover only a portion of the curved sheet of planar thermal conductive material in order to leave some of the planar thermal conductive material exposed.

Any one or a combination of a metal layer, polymer layer, and/or mesh can be applied to a surface of the planar thermal conductive material during a roll forming and/or a press forming operation, such as those described above for forming a bent portion of the heat dissipating device.

Any one or a combination of a metal layer, polymer layer, and/or mesh can be applied can be applied to a flat sheet of planar thermal conductive material before the bent portion is formed.

Any one or a combination of a metal layer, polymer layer, and/or mesh can be applied can be applied to a curved sheet of planar thermal conductive material after the bent portion is formed.

In any of the embodiments described above, the planar thermal conductive material can be pyrolytic graphite as described above. Portions of the heat dissipating device which consist essentially of planar thermal conductive material may include small amounts of other elements which still allow those portions of the heat dissipating device to have greater thermal conductivity in directions on or parallel to a-b planes as compared to directions in c-directions.

As mentioned above, the compositional purity of the planar thermal conductive material will affect thermal conductivity. In some embodiments, heat dissipating device 20, 70 is constructed such that its thermal conductivity in a first direction corresponding to a-b planes of is at least 100 times or at least 200 times that in a second direction corresponding to a c-direction.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. All variations of the features of the invention described above are considered to be within the scope of the appended claims. It is not intended that the invention be limited, except as by the appended claims.

1. A device for dissipating heat from a heat source, the device comprising:
a sheet including a flat first portion and a bent second portion integrally formed on the first portion, wherein each of the first portion and the second portion has a core substrate that consists essentially of pyrolytic graphite, and a-b planes of the pyrolytic graphite at a center region of the first portion and the second portion follow a surface contour of the first portion and the second portion.

2. The device of claim 1, wherein the a-b planes at the center region of the second portion have a bend angle of at least 15°.

3. The device of claim 1, wherein the sheet further includes a flat third portion integrally formed on the second portion, the third portion consists essentially of pyrolytic graphite, and central a-b planes of the pyrolytic graphite running between the first portion and the third portion bend at least 15°.

4. The device of claim 3, wherein the sheet further includes a curved fourth portion integrally formed on the third portion, the fourth portion consists essentially of pyrolytic graphite, and a-b planes at a center region of the fourth portion have a bend angle of at least 15°.

5. The device of claim 1, further comprising a cover disposed over any one or more of the portions of the sheet.

6. The device of claim 5, wherein the cover includes two opposing layers, and any one or more of the portions of the sheet is or are disposed between the two opposing layers.

7. The device of claim 5, wherein all the portions of the sheet are sealed within the cover.

8. The device of claim 5, wherein the cover includes a metal foil.

9. The device of claim 5, wherein the cover includes a polymer layer having a greater dielectric resistance relative to underlying material beneath the polymer layer.

10. The device of claim 5, wherein the cover includes a metal mesh configured to accommodate a difference in thermal expansion between the sheet and a heat source to be thermally coupled to the sheet.

11. A system for dissipating heat, the system comprising:
the device of claim 1; and
a heat source thermally coupled to the device.

12. A method for making a heat dissipating device, the method comprising:
bending a sheet of pyrolytic graphite to form a bent portion, wherein a-b planes of the pyrolytic graphite at a center region of the bent portion follow a curved surface contour of the bent portion.

13. The method of claim 12, wherein the bending step includes bending central a-b planes at least 15°.

14. The method of claim 12, wherein after the bending step, two portions of the sheet are flat, and the bent portion is disposed between the two portions.

15. The method of claim 14, wherein the two flat portions are offset and parallel to each other.

16. The method of claim 14, wherein a-b planes at center regions of the two flat portions are flat, and the a-b planes at the center region of the bent portion are curved.

17. The method of claim 12, wherein the bending step includes one or both of roll forming and press forming.

18. The method of claim 12, further comprising applying a cover over the bent portion or another portion of the sheet.

19. The method of 18, wherein the cover includes any one or more of a metal layer portion, a polymer layer portion, and a mesh portion.

20. The method of claim 18, wherein at least one portion of the cover is applied during the bending step.
